(19) United States
(12) Patent Application Publication
(10) Pub. No.: US 2018/0281919 A1
(43) Pub. Date: Oct. 4, 2018

(54) Aircraft fuselage and aircraft with same

(71) Applicant: YUNEEC TECHNOLOGY CO., LIMITED, Hong kong (CN)

(72) Inventors: Yu Tian, Kunshan, Jiangsu (CN); Wenyan Jiang, Kunshan, Jiangsu (CN)

(21) Appl. No.: 15/562,802

(22) PCT Filed: Apr. 8, 2016
(86) PCT No.: PCT/CN2016/078860

§ 371 Date: Sep. 28, 2017

(30) Foreign Application Priority Data
Apr. 8, 2015 (CN) 201510163563.7
Apr. 8, 2015 (CN) 201520208497.6

(51) Int. Cl. B64C 1/06; B64D 27/24; B64D 9/00; B64D 47/02; B64C 25/04

(52) U.S. Cl. CPC B64C 1/069; B64D 27/24; B64C 39/024; B64D 47/02; B64C 25/04; B64D 9/00

(57) ABSTRACT

The present invention provides an aircraft housing and an aircraft with the same. The aircraft housing includes an upper housing and a lower housing. The upper and lower housings are connected through ultrasonic welding or gluing. The aircraft housing has a cavity therein which is communicated with at least one opening of the lower housing. A power system is located within the cavity through the opening. In the present invention, the upper and lower housings of the aircraft are connected through ultrasonic welding, and the aircraft is formed by one step and is high in good product rate. Meanwhile, the aircraft housing is processed through welding, so that the upper and lower housing are in seamless connection with each other, the contact surface suffers from stress, and the strength is substantially increased.

### CROSS REFERENCE OF RELATED APPLICATION

This is a U.S. National Stage under 35 U.S.C 371 of the International Application PCT/CN2016/078860, filed Apr. 8, 2016, which claims priority under 35 U.S.C. 119(a-d) to CN 201520208497.6, filed Apr. 8, 2015; and CN 201510163563.7, filed Apr. 8, 2015. All contents of the priority document are included into this application by reference.

### BACKGROUND OF THE PRESENT INVENTION

### Field of Invention

The present invention relates to an aircraft housing and an aircraft with the same.

### Description of Related Arts

In existing aircrafts, firstly, a power system needs to be installed within an upper housing or a lower housing, and then the upper and lower housings are closed and fixedly connected. Moreover, the upper and lower housings of the aircraft are mostly connected through screws, wherein screw fixation places are taken as force-bearing points and the whole aircraft housing is lower in strength. If an amount of the screws is added to enhance the housing strength, a weight of the aircraft is added, which is not conductive to improving the performance of the aircraft. Meanwhile, the assembly based on screw connection is difficult, the housings of the medium-sized and large-sized aircrafts are generally locked through dozens of screws with different sizes, so that labor cost is high and good product rate is low.

In addition, generally, after the installation of the components within the aircraft is completed, the upper and lower housings are closed, so that the aircraft is complex in assembly and process, time consuming and labor intensive, and prone to assembly errors, which may result in quality defects in the assembled product.

### SUMMARY OF THE PRESENT INVENTION

A technical problem to be solved is to provide an aircraft housing and an aircraft with the same which is able to overcome defects of the prior art that the aircraft housing is heavy in weight and poor in housing strength, the installation of the aircraft is time consuming and labor intensive due to an installation process comprising firstly installing a power system, and then closing an upper housing and a lower housing of the aircraft, and then connecting the upper and lower housings through screws.

The present invention overcomes the above technical problems through a technical solution as follows.

An aircraft housing comprises an upper housing and a lower housing, wherein the upper housing is connected with the lower housing through ultrasonic welding or gluing, the aircraft housing has a cavity therein which is communicated with at least one opening on the lower housing, and a power system is located within the cavity through the opening.

In the present invention, through improvements on the aircraft housing, the upper housing and the lower housing are firstly connected together, and then the power system is installed, so that an assembly of the aircraft housing is simplified. The upper and lower housings of the aircraft housing of the present invention are connected through ultrasonic welding or gluing, in such a manner that the upper and lower housings of the aircraft housing are in seamless connection with each other, so that the contact surface instead of the contact point (through screw connection) suffers from stress, so as to substantially improve the housing strength. Moreover, the integrated aircraft housing is light in weight and is convenient for production, thus greatly improving the production efficiency.

Preferably, a welding strip is located at a docking face of the upper housing, the lower housing has a welding groove on a docking face thereof, and the welding strip is docked with the welding groove.

The welding strip is able to be inserted into the welding groove for aligning the upper housing with the lower housing before ultrasonic welding to more accurately connect the upper housing with the lower housing. Meanwhile, during the ultrasonic welding process, the welding strip of the upper housing is softened and molten with the welding groove into a whole, so as to fixedly connect the upper housing with the lower housing, to greatly improve the structural strength.

Preferably, the welding strip is set around the upper housing, the welding groove is correspondingly provided around the lower housing.

The welding strip with a complete circle is connected with the welding groove to increase a welding surface for firming a connection of the upper and lower housings.

Preferably, the power system comprises a main control board and a battery.

For the electrically-driven aircraft, the power system comprises the main control board and the battery, wherein the main control board is able to drive a rotor motor to rotate, so as to provide power for flight, and the battery is adapted for providing the main control board with electricity.

Preferably, the aircraft housing further comprises a sensor housing fixing mechanism and has a slot on an external surface thereof for fixing a sensor housing;

the sensor housing fixing mechanism comprises: a housing body for accommodating a sensor; an engaging part cooperated with the slot, wherein the engaging part has two side walls which are parallel to a connecting line of a front portion and a tail portion of the aircraft housing, and an opening is provided on a top of the engaging part; and an engaging cooperating part located at a lower end of the housing body and connected the housing body with the engaging part, wherein the engaging part is connected with the engaging cooperating part through a shaft.

The sensor housing fixing mechanism of the aircraft is able to be easily detached from the aircraft without disassembling the aircraft housing, which is convenient for replacing and updating. Moreover, the sensor housing fixing mechanism is able to be simultaneously in an unfold aircraft housing state and a fold aircraft housing state, so that it is convenient for being transported relatively to the sensor housing of the conventional aircraft, and is not easy to be damaged in transit.

Preferably, the aircraft housing further comprises a lampshade fixing mechanism which comprises: a lamp chamber located on the aircraft housing for accommodating a lamp; and a lampshade cooperated with the lamp chamber, wherein:

the lamp chamber has an annular side wall, the annular side wall has at least two installing holes; at least two protruding objects respectively cooperated with the installing holes are located on the lampshade; each of the protruding objects comprises an extension part extended along a vertical direction; a boss, extended outwardly to an exterior of the lampshade, is located at a free end of the extension part towards the lamp chamber; a transition surface is provided on a vertical side wall, which contacts with the installing holes while respectively loosening the protruding objects and the installing holes.

The lampshade fixing mechanism is simple in structure, is convenient for being assembled and disassembled and simultaneously effectively reduces a dead weight of the aircraft.

Preferably, the aircraft housing further comprises a battery pack which comprises a battery housing, at least one battery core is located within the battery housing, a positive end and a negative end of the battery core are respectively connected with a charge and discharge interface through a first charge balance line and a second charge balance line, the charge and discharge interface comprises at least one charge port and one discharge port, and the charge and discharge interface is provided on the battery housing.

The battery pack and the aircraft with the battery pack are simple in structure convenient for being used, and able to effectively protect the battery through the battery housing and simultaneously simplify the operation steps of charging and discharging.

Preferably, the aircraft housing further comprises a landing gear which comprises: a support unit for supporting an aircraft; and a fixing unit located at a top surface of the support unit and connected with the aircraft housing through buckling, wherein while being pressed, the fixing unit is able to be taken out of the aircraft housing.

The fixing unit of the landing gear is buckled with the aircraft housing, and is able to be taken out of the aircraft housing while being pressed, such that when the landing gear is disassembled from the aircraft housing, no special tool is needed, so as to facilitate assembling and disassembling; meanwhile, when the landing gear is damaged, it is easy to replace the landing gear for reducing the using cost; during the process of transporting the aircraft, the landing gear is convenient for being assembling and disassembling to facilitate transporting the aircraft, the transport space is greatly saved and the transport cost is reduced.

Preferably, the aircraft housing has a battery compartment and an internal accommodating chamber, the battery compartment is adapted for accommodating the battery pack, the internal accommodating chamber is provided at an inner side of the battery compartment and within the aircraft housing, the internal accommodating chamber is adapted for accommodating at least one aircraft internal unit, at least one aircraft internal unit is able to enter the internal accommodating chamber through an opening of the battery compartment.

The antenna, the battery and other components are convenient for being installed to the aircraft housing; the battery compartment and the internal accommodating chamber allow the internal components of the aircraft, such as the main control board, to be post-installed, which significantly improves the operability and convenience.

In the present invention, the above preferred conditions are able to be arbitrarily combined based on common sense in the field to obtain some preferred embodiment of the present invention.

Positive progressive effects of the present invention are as follows. The present invention adopts the ultrasonic welding or gluing technology to connect the upper and lower housings of the aircraft, so that the aircraft is formed by one step and is high in good product rate.

### BRIEF DESCRIPTION OF THE DRAWINGS

FIG. 1 is a structurally schematic view of an aircraft housing according to a first preferred embodiment of the present invention.

FIG. 2 is a top view of FIG. 1.

FIG. 3 is a sectional view of FIG. 2 along A-A.

FIG. 4 is a rear side structural diagram of the aircraft housing according to the first preferred embodiment of the present invention.

FIG. 5 is a stereogram of an aircraft housing from a visual angle according to a second preferred embodiment of the present invention.

FIG. 6 is a stereogram of the aircraft housing from another visual angle according to the second preferred embodiment of the present invention.

FIG. 7 is a partially schematic view of an aircraft.

FIG. 8 is a structurally schematic view of a landing gear.

FIG. 9 is an internal schematic view of a lampshade fixing mechanism.

FIG. 10 is a three-dimensionally schematic view of the lampshade fixing mechanism.

FIG. 11 is a structurally schematic view of a sensor housing fixing mechanism.

### DETAILED DESCRIPTION OF THE PREFERRED EMBODIMENT

### First Embodiment

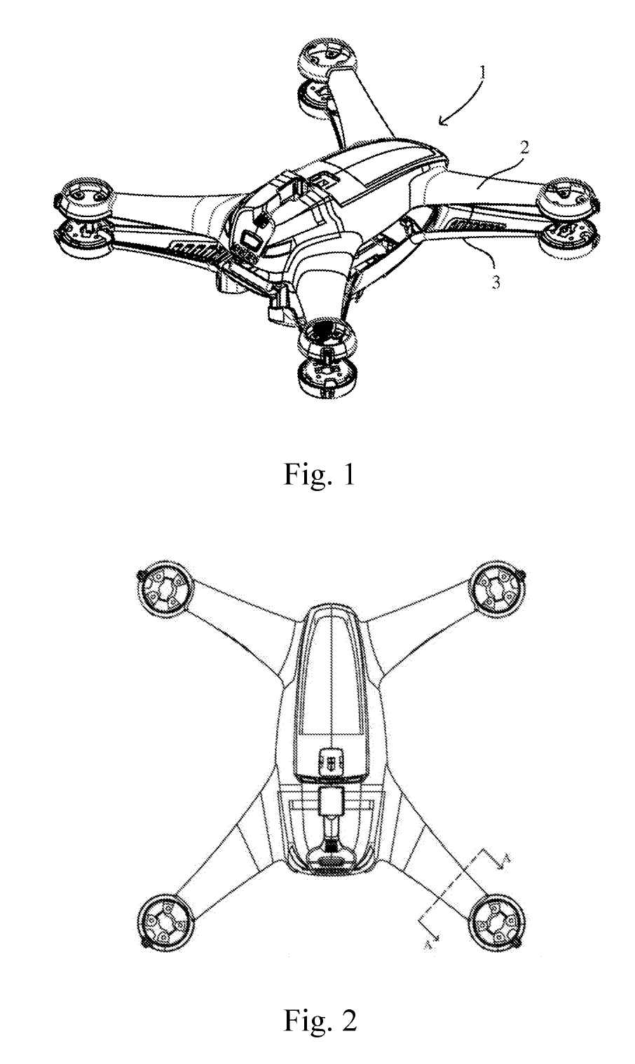

FIG. 1 shows an aircraft housing 1 which comprises an upper housing 2 and a lower housing 3, wherein the upper housing is connected with the lower housing through ultrasonic welding or gluing. As shown in FIG. 4, the aircraft housing 1 has a cavity 4 therein which is communicated with at least one opening 5 on the lower housing. A power system 20 is located within the cavity through the opening.

The aircraft housing provided by the present invention has a larger cavity therein which is communicated with an exterior through the opening on the lower housing, so that the power system is able to be installed on the aircraft housing after the aircraft housing is completed. The opening on the lower housing provides enough space for the post-installed power system. In this embodiment, the power system comprises a main control board 201 and a battery 202. The main control board is able to drive a rotor motor to rotate, so as to provide power for flight. The battery is adapted for providing the main control board with electricity. Of course, the present invention is not limited to the electrically-driven aircraft, and is also adapted for aircrafts which are provided with power by other power systems.

For the present invention, after the housing integration is completed, the main control board and the battery are installed within the housing. A motor, located at a tail end of an airfoil, is easily connected with the main control board. To easier connection, the lower housing of the present invention has two openings, one is close to a head portion of the aircraft, the other is close to a tail portion of the aircraft, so that two motors at a front end and two motors at a rear end are easily connected with the main control board through a front opening and a rear opening, respectively. The two openings are covered with an extra cover plate after an installation of components within the aircraft is completed. Preferably, when the battery is installed in position, the rear opening is able to be closed simultaneously through an own structure of the battery.

In the present invention, through improvements on the aircraft housing, the upper housing and the lower housing are firstly connected together, and then the power system is installed, so that an assembly of the aircraft housing is simplified. The upper and lower housings of the aircraft housing of the present invention are connected through ultrasonic welding or gluing, in such a manner that the upper and lower housings of the aircraft housing are in seamless connection with each other, so that the contact surface instead of the contact point (through screw connection) suffers from stress, so as to substantially improve the housing strength. Moreover, the integrated aircraft housing is light in weight and is convenient for production, thus greatly improving the production efficiency.

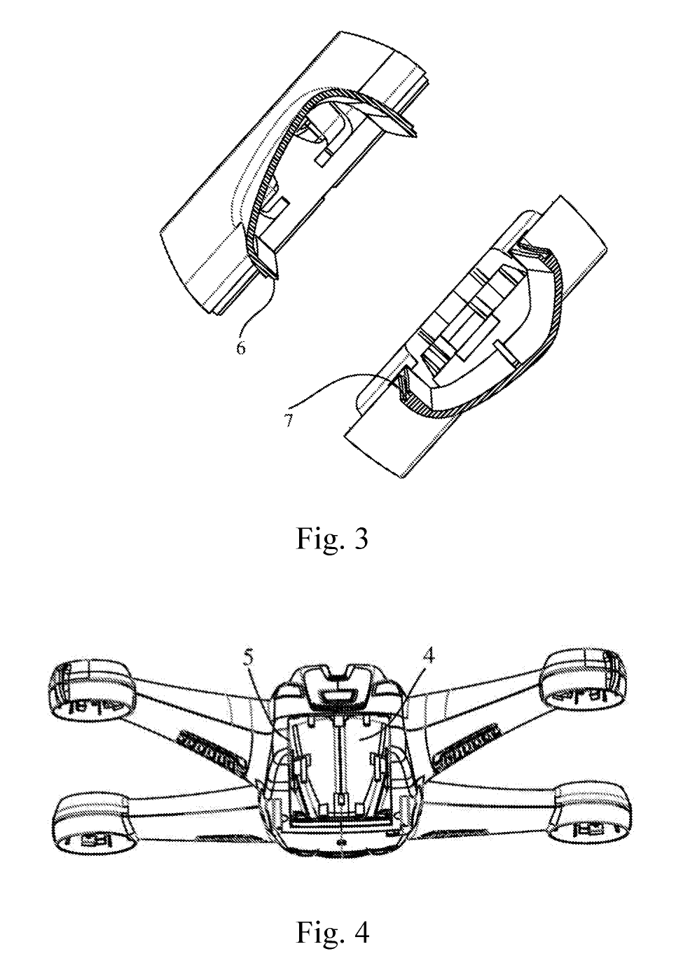

In this embodiment, as shown in FIGS. 2 and 3, a welding strip 6 is located at a docking face of the upper housing, the lower housing has a welding groove 7 on a docking face thereof, and the welding strip is docked with the welding groove. The welding strip is able to be inserted into the welding groove for aligning the upper housing with the lower housing before ultrasonic welding, so as to more accurately connect the upper housing with the lower housing. Meanwhile, during the ultrasonic welding process, the welding strip of the upper housing is softened and molten with the welding groove into a whole, so as to fixedly connect the upper housing with the lower housing, to greatly improve the structural strength. Of course, the present invention is not limited to achieve the ultrasonic welding through the welding strip and the welding groove, and is also able to achieve the ultrasonic welding through other methods. Even if there are only the docking face of the upper housing and the docking face of the lower housing, the ultrasonic welding is able to be completed.

In this embodiment, the welding strip is set around the upper housing for a circle, the welding groove is correspondingly provided around the lower housing for a circle. The welding strip with the complete circle is connected with the welding groove with the complete circle to increase a welding surface for firming a connection of the upper and lower housings. Of course, the present invention is not limited to adopt the welding strip with the complete circle and the welding groove with the complete circle, and is able to adopt the ultrasonic welding at important positions and screw connection at other positions. For example, in actual applications, for a multi-rotor aircraft, due to the airfoils are close to the motors, the requirements on the stability and the airfoil strength are higher during the rotation of the motors, so that the airfoils are integrated through ultrasonic welding and other positions are fixed through screws.

Moreover, in this embodiment, the integrated aircraft housing further comprises a sensor housing fixing mechanism 50, and a lampshade fixing mechanism 40, and is connected with the battery pack, all of which are convenient for being installed.

Specifically, the aircraft housing has a slot on an external surface thereof for fixing a sensor housing;

the sensor housing fixing mechanism 50 comprises: a housing body 501 for accommodating a sensor; an engaging part 502 cooperated with the slot, wherein the engaging part has two side walls 503 which are parallel to a connecting line of a front portion and a tail portion of the aircraft housing, and an opening 504 is provided on a top of the engaging part; and an engaging cooperating part 505 located at a lower end of the housing body and connected the housing body with the engaging part, wherein the engaging part is connected with the engaging cooperating part through a shaft 506.

The lampshade fixing mechanism 40 comprises: a lamp chamber 407 located on the aircraft housing for accommodating a lamp; and a lampshade 401 cooperated with the lamp chamber, wherein:

the lamp chamber has an annular side wall 402, the annular side wall has at least two installing holes 408; at least two protruding objects 403 respectively cooperated with the installing holes are located on the lampshade; each of the protruding objects comprises an extension part 404 extended along a vertical direction; a boss 405, extended outwardly to an exterior of the lampshade, is located at a free end of the extension part towards the lamp chamber; a transition surface 406 is provided on a vertical side wall, which contacts with the installing holes while respectively loosening the protruding objects and the installing holes.

The battery pack comprises a battery housing, at least one battery core is located within the battery housing, a positive end and a negative end of the battery core are respectively connected with a charge and discharge interface through a first charge balance line and a second charge balance line, the charge and discharge interface comprises at least one charge port and one discharge port, and the charge and discharge interface is provided on the battery housing.

A landing gear 30 comprises: a support unit 301 for supporting an aircraft; and a fixing unit 302 located at a top surface of the support unit and connected with the aircraft housing through buckling, wherein while being pressed, the fixing unit is able to be taken out of the aircraft housing.

It can be seen from the above description that the upper and lower housings of the aircraft housing of the present invention are connected through the ultrasonic welding process, so that the upper and lower housings are formed by one step and the aircraft housing is high in good product rate; meanwhile, the aircraft housing manufacture by the ultrasonic welding process, the upper and lower housings are in seamless connection with each other, the contact surface is stressed, and the strength is greatly improved.

### Second Embodiment

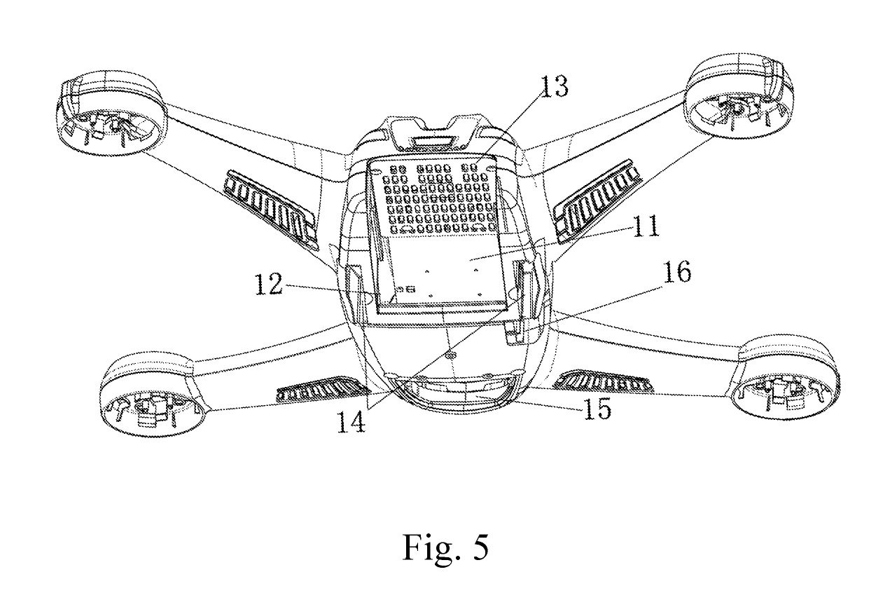

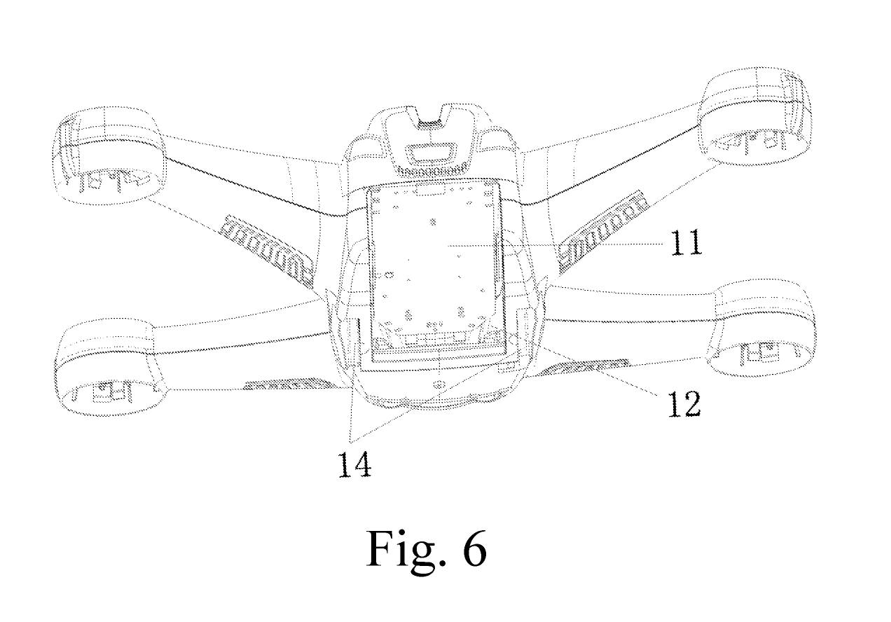

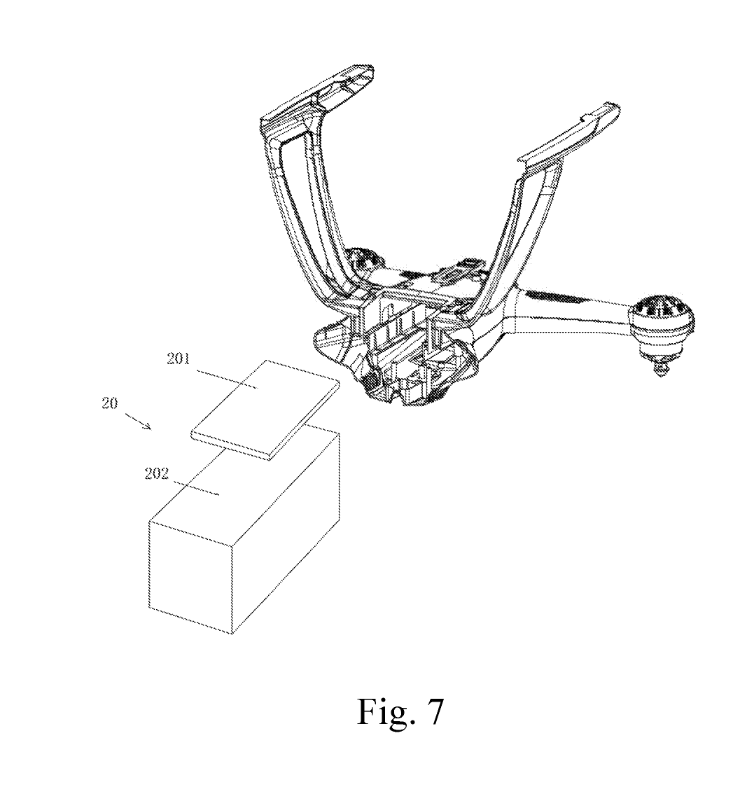

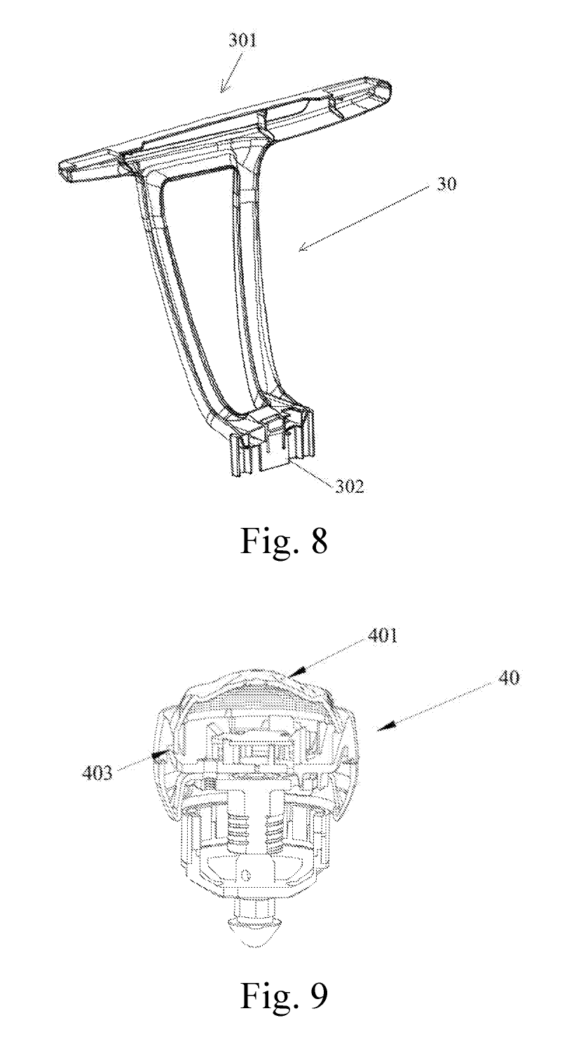

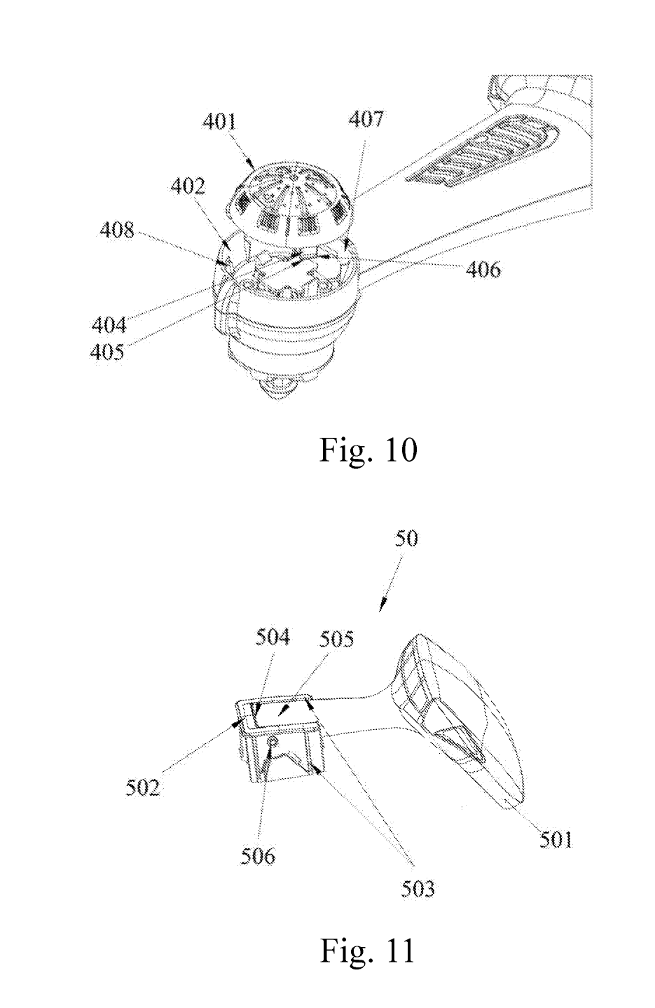

The aircraft, embodied as a remote control aircraft according to a second preferred embodiment of the present invention, referring to FIGS. 5 and 6 (which mainly show a lower portion of an aircraft housing), comprises an aircraft housing. The aircraft housing comprises a battery compartment 12, an internal accommodating cavity, an antenna port, two wire connection ports 15 and 16, a wire connection cover, a baffle 13 and a landing gear interface 14.

The battery compartment 12 is provided at the lower portion of the aircraft housing and adapted for accommodating a battery pack. The internal accommodating cavity is provided inside the battery compartment and within the aircraft housing to accommodate a main control board 11 (namely, the internal accommodating cavity is just at the main control board 11 in FIG. 5). The main control board enters the internal accommodating cavity through an opening of the battery compartment; or the opening of the battery compartment is big enough to allow the main control board to be placed within the aircraft housing. It should be noted that connection wires of a motor, an LED (light emitting diode) lamp and other some aircraft components are able to be connected with the main control board 11 within the internal accommodating cavity through the battery compartment, so as to facilitate installing or connecting the aircraft components.

Specifically, the LED lamp and the motor are located on a housing wall of the aircraft housing; factually, two ends of the connection wires of the LED, the motor and the main control board should be respectively located at the housing wall and the internal accommodating cavity. The housing wall of the aircraft housing forms a housing chamber while defining the aircraft housing, the connection wires start from the LED lamp and the motor on the housing wall, and then pass through the housing chamber and the battery compartment in turn, and then reach the internal accommodating cavity, and finally connect with corresponding ports on the main control board, so as to achieve a connection among the LED lamp, the motor and the main control board, which means that any connection wire is not exposed to an exterior of the aircraft housing, and meanwhile, an installation of various components and connection wires is completed after the whole housing structure is machined and formed. Therefore, a whole installation process is extremely convenient and flexible.

However, based on different settings of the ports of the main control board 11, a part of the ports of the main control board located within the internal accommodating cavity are inconvenient for connecting the connection wires of the aircraft components corresponding to the part of the ports with the main control board 11 through the battery compartment. Therefore, the present invention comprises a wire connection port 15 located at the lower portion of the aircraft housing to facilitate allowing some components, such as GPS antennas and the connection wires of the motor located at a front end of the aircraft housing, to pass through and connect with the corresponding ports of the main control board 11. The present invention also comprises an externally-connected RF (radio frequency) port. However, it should be noted that the wire connection ports 15 and 16 are not indispensable for connecting the components with the main control board 11.

The wire connection port 16, located near the landing gear interface at a right side of the aircraft housing, is relatively small for acting as a gimbal control port and USB (universal serial bus) port of the main control board. When the connection of the main control board 11 and a part of the aircraft components is completed, the wire connection port 16 is adapted for connecting a gimbal with the main control board without affecting the part of the aircraft components which have been installed or connected. Meanwhile, the wire connection port 16 acting as the USB port is greatly convenient for updating the software system of the aircraft and transmitting data between the aircraft and external devices.

The antenna port is adapted for inserting a housing structure of an antenna in a detachable manner to connect and fix the antenna. A contact surface of the battery compartment and the battery pack has at least one guiding groove, an extension direction of the guiding groove is perpendicular to a direction along an opening of the battery compartment, and a horn-shaped guiding mouth is provided at a front end of every guiding slot. The baffle 13 is located at one side of the battery compartment for separating the connection wires of at least one aircraft component from the battery compartment.

The wire connection cover, adapted for closing the wire connection ports, is located at the lower portion of the aircraft housing. The antenna port is located at an upper port of the aircraft housing. It should be understood that FIG. 5 only illustrative shows the two wire connection ports 15 and 16, and an amount and positions of the wire connection ports are able to be flexibly set as required.

The landing gear interface 14 is located at the lower portion of the aircraft housing for detachably fixing a landing gear. The landing gear interface has two sliding channels respectively provided at a left side wall and a right side wall at the lower portion of the aircraft housing and a positioning channel communicated with the two sliding channels, wherein the sliding channels are adapted for connecting fixing components of a landing gear and the positioning channel is adapted for locking the landing gear.

### Third Embodiment

An aircraft is disclosed in this embodiment, which comprises an aircraft housing described in any one of the above first and second embodiments.

The specific embodiments of the present invention have been described above, and however, it will be understood by those skilled in the art that these embodiments are illustrative only and the protective scope of the present invention is defined by the appended claims. It will be apparent to those skilled in the art that various changes and modifications can be made in these embodiments without departing from the principles and spirit of the present invention, but these changes and modifications are within the protective scope of the present invention.

1-10. (canceled)

11: An aircraft housing, comprising an upper housing and a lower housing, wherein the upper housing is connected with the lower housing through ultrasonic welding or gluing, the aircraft housing has a cavity therein which is communicated with at least one opening on the lower housing.

12: The aircraft housing, as recited in claim 11, wherein a welding strip is located at a docking face of the upper housing, the lower housing has a welding groove on a docking face thereof, and the welding strip is docked with the welding groove.

13: The aircraft housing, as recited in claim 12, wherein the welding strip is set around the upper housing for a circle, the welding groove is correspondingly provided around the lower housing for a circle.

14: The aircraft housing, as recited in claim 12, wherein the aircraft housing further comprises a sensor housing fixing mechanism and has a slot on an external surface thereof for fixing a sensor housing, wherein the sensor housing fixing mechanism comprises:
a housing body for accommodating a sensor;
an engaging part cooperated with the slot, wherein the engaging part has two side walls which are parallel to a connecting line of a front portion and a tail portion of the aircraft housing, and an opening is provided on a top of the engaging part; and
an engaging cooperating part located at a lower end of the housing body and connected the housing body with the engaging part, wherein the engaging part is connected with the engaging cooperating part through a shaft.

15: The aircraft housing, as recited in claim 13, wherein the aircraft housing further comprises a sensor housing fixing mechanism and has a slot on an external surface thereof for fixing a sensor housing, wherein the sensor housing fixing mechanism comprises:
a housing body for accommodating a sensor;
an engaging part cooperated with the slot, wherein the engaging part has two side walls which are parallel to a connecting line of a front portion and a tail portion of the aircraft housing, and an opening is provided on a top of the engaging part; and
an engaging cooperating part located at a lower end of the housing body and connected the housing body with the engaging part, wherein the engaging part is connected with the engaging cooperating part through a shaft.

16: The aircraft housing, as recited in claim 14, further comprising a lampshade fixing mechanism which comprises:
a lamp chamber located on the aircraft housing for accommodating a lamp; and
a lampshade cooperated with the lamp chamber, wherein:
the lamp chamber has an annular side wall, the annular side wall has at least two installing holes; at least two protruding objects respectively cooperated with the installing holes are located on the lampshade; each of the protruding objects comprises an extension part extended along a vertical direction; a boss, extended outwardly to an exterior of the lampshade, is located at a free end of the extension part towards the lamp chamber; a transition surface is provided on a vertical side wall, which contacts with the installing holes while respectively loosening the protruding objects and the installing holes.

17: The aircraft housing, as recited in claim 15, further comprising a lampshade fixing mechanism which comprises:
a lamp chamber located on the aircraft housing for accommodating a lamp; and
a lampshade cooperated with the lamp chamber, wherein:
the lamp chamber has an annular side wall, the annular side wall has at least two installing holes; at least two protruding objects respectively cooperated with the installing holes are located on the lampshade; each of the protruding objects comprises an extension part extended along a vertical direction; a boss, extended outwardly to an exterior of the lampshade, is located at a free end of the extension part towards the lamp chamber; a transition surface is provided on a vertical side wall, which contacts with the installing holes while respectively loosening the protruding objects and the installing holes.

18: The aircraft housing, as recited in claim 16, wherein:
the aircraft housing has a battery compartment and an internal accommodating chamber, the battery compartment is adapted for accommodating a battery pack, the internal accommodating chamber is provided at an inner side of the battery compartment and within the aircraft housing, the internal accommodating chamber is adapted for accommodating at least one aircraft internal unit, at least one aircraft internal unit is able to enter the internal accommodating chamber through an opening of the battery compartment.

19: The aircraft housing, as recited in claim 17, wherein:
the aircraft housing has a battery compartment and an internal accommodating chamber, the battery compartment is adapted for accommodating a battery pack, the internal accommodating chamber is provided at an inner side of the battery compartment and within the aircraft housing, the internal accommodating chamber is adapted for accommodating at least one aircraft internal unit, at least one aircraft internal unit is able to enter the internal accommodating chamber through an opening of the battery compartment.

20: An aircraft, comprising an aircraft housing, a power system, a battery pack and a landing gear, wherein:
the aircraft housing comprises an upper housing and a lower housing, wherein the upper housing is connected with the lower housing through ultrasonic welding or gluing, the aircraft housing has a cavity therein which is communicated with at least one opening on the lower housing;
the power system, located within the cavity through the opening, comprises a main control board and a battery;
the battery pack comprises a battery housing, wherein at least one battery core is located within the battery housing, a positive end and a negative end of the battery core are respectively connected with a charge and discharge interface through a first charge balance line and a second charge balance line, the charge and discharge interface comprises at least one charge port and one discharge port, and the charge and discharge interface is provided on the battery housing;
the landing gear comprises a support unit for supporting an aircraft and a fixing unit located at a top surface of the support unit and connected with the aircraft housing through buckling, wherein while being pressed, the fixing unit is able to be taken out of the aircraft housing.

21: The aircraft, as recited in claim 20, wherein a welding strip is located at a docking face of the upper housing, the lower housing has a welding groove on a docking face thereof, and the welding strip is docked with the welding groove.

22: The aircraft, as recited in claim 21, wherein the welding strip is set around the upper housing for a circle, the welding groove is correspondingly provided around the lower housing for a circle.

23: The aircraft, as recited in claim 21, wherein the aircraft housing further comprises a sensor housing fixing mechanism and has a slot on an external surface thereof for fixing a sensor housing, wherein the sensor housing fixing mechanism comprises:
a housing body for accommodating a sensor;
an engaging part cooperated with the slot, wherein the engaging part has two side walls which are parallel to a connecting line of a front portion and a tail portion of the aircraft housing, and an opening is provided on a top of the engaging part; and
an engaging cooperating part located at a lower end of the housing body and connected the housing body with the engaging part, wherein the engaging part is connected with the engaging cooperating part through a shaft.

24: The aircraft, as recited in claim 22, wherein the aircraft housing further comprises a sensor housing fixing mechanism and has a slot on an external surface thereof for fixing a sensor housing, wherein the sensor housing fixing mechanism comprises:
a housing body for accommodating a sensor;
an engaging part cooperated with the slot, wherein the engaging part has two side walls which are parallel to a connecting line of a front portion and a tail portion of the aircraft housing, and an opening is provided on a top of the engaging part; and
an engaging cooperating part located at a lower end of the housing body and connected the housing body with the engaging part, wherein the engaging part is connected with the engaging cooperating part through a shaft.

25: The aircraft, as recited in claim 23, wherein the aircraft housing further comprises a lampshade fixing mechanism which comprises:
a lamp chamber located on the aircraft housing for accommodating a lamp; and
a lampshade cooperated with the lamp chamber, wherein:
the lamp chamber has an annular side wall, the annular side wall has at least two installing holes; at least two protruding objects respectively cooperated with the installing holes are located on the lampshade; each of the protruding objects comprises an extension part extended along a vertical direction; a boss, extended outwardly to an exterior of the lampshade, is located at a free end of the extension part towards the lamp chamber; a transition surface is provided on a vertical side wall, which contacts with the installing holes while respectively loosening the protruding objects and the installing holes.

26: The aircraft, as recited in claim 24, wherein the aircraft housing further comprises a lampshade fixing mechanism which comprises:
a lamp chamber located on the aircraft housing for accommodating a lamp; and
a lampshade cooperated with the lamp chamber, wherein:
the lamp chamber has an annular side wall, the annular side wall has at least two installing holes; at least two protruding objects respectively cooperated with the installing holes are located on the lampshade; each of the protruding objects comprises an extension part extended along a vertical direction; a boss, extended outwardly to an exterior of the lampshade, is located at a free end of the extension part towards the lamp chamber; a transition surface is provided on a vertical side wall, which contacts with the installing holes while respectively loosening the protruding objects and the installing holes.

27: The aircraft, as recited in claim 25, wherein:
the aircraft housing has a battery compartment and an internal accommodating chamber, the battery compartment is adapted for accommodating a battery pack, the internal accommodating chamber is provided at an inner side of the battery compartment and within the aircraft housing, the internal accommodating chamber is adapted for accommodating at least one aircraft internal unit, at least one aircraft internal unit is able to enter the internal accommodating chamber through an opening of the battery compartment.

28: The aircraft, as recited in claim 26, wherein:
the aircraft housing has a battery compartment and an internal accommodating chamber, the battery compartment is adapted for accommodating a battery pack, the internal accommodating chamber is provided at an inner side of the battery compartment and within the aircraft housing, the internal accommodating chamber is adapted for accommodating at least one aircraft internal unit, at least one aircraft internal unit is able to enter the internal accommodating chamber through an opening of the battery compartment.
